(19) United States
(12) Patent Application Publication
(10) Pub. No.: US 2018/0211014 A1
(43) Pub. Date: Jul. 26, 2018

(54) METHOD AND SYSTEM FOR PROVIDING, TO PAPER BOOK BUYER, DIGITAL CONTENT COMPLEMENTARY TO PAPER BOOK

(71) Applicant: Boyeon Jung, Seoul (KR)

(72) Inventor: Boyeon Jung, Seoul (KR)

(21) Appl. No.: 15/561,276

(22) PCT Filed: Jun. 16, 2015
(86) PCT No.: PCT/KR2015/006063

§ 371 Date: Sep. 25, 2017

(30) Foreign Application Priority Data
Mar. 25, 2015 (KR) 10-2015-0041823

(51) Int. Cl. G06F 21/10; G06F 21/32; G06Q 20/12

(52) U.S. Cl. CPC G06F 21/10; G06Q 20/1235; G06F 21/32

(57) ABSTRACT

The owner (B) of a copy (A) of a specific paper book inputs his/her copy (A) into a machine (C) of a system. (C), for example, a vending machine, acquires the paper book and then requests user authentication to (B). (B) identifies the identification card and his/her fingerprint to the machine. The machine transmits the acquired information to the system server, and the system server recognizes that (B) is the specific system user (B′) registered in the system and (B′) owns (A). Thereafter, the system server allows (B′) access to the digital content associated with (A). Then, the system server creates an “authenticator behavior rule (D)” unique to (A) and presents the same to (C). (C) leaves a physical mark somewhere in (A) and returns the same to (B) according to (D) received. (B) accesses the system server through his/her own client device, requests a system service from the system server after a user/device authentication process, and receives the service (a usage right, an access right, etc. according to a specific usage rule) so as to experience the digital content associated with (A).

There might be a case in which (B) is a “stealer” for (A) (in other words, in a case in which (B), who does not own (A), is issued with the system service by deceiving as if he/she owns the book by renting/stealing the same). At this point, the actual owner (E) of (A) appears, putting (A) into (C) and asking to find out who has stolen the system service. (C) asks the system server for help, and the system server refers to the internal protocol and guides the position (C) where there might be a physical mark. (C) searches for the physical mark and transmits the found physical mark attribute value to the system server in accordance with this guidance. The system server can grasp that (B′) is the stealer based on the received information, interrupts the system service having been provided to (B′) from that point, newly register (E) as the owner, and provides the system service to (E). In addition, (B) is designated as a “stealer” and is punished by the law, thereby maintaining the system-wide security.

The present invention relates to a method for allowing only a buyer of a specific paper book to experience a digital content complementary to the specific paper book.

### BACKGROUND ART

To attract the majority of consumers who hesitate to choose between the pros and cons of paper books and e-books, publishers have searched for new publishing and distribution channels in various ways. They are well aware of the fact that the consumers want to buy paper books because of the familiarity and visibility thereof but are hesitant to buy the paper books because of the inconvenience of portability, storability, and information dissemination. Thus, they want to overcome this by providing complementary digital content for paper books so that consumers who buy paper books can also experience the benefits of e-books. On the other hand, in addition to publishers who expect to increase the consumption of paper books, there is a strong demand from consumers who want new distribution channels. Consumers want to take advantage of the electronic version conveniently by digitizing their current paper book and putting the same on their portable device. Thus, there are ways in which they try on their own. These methods, along with the attempts of the publishers mentioned above, inherently have elements that are impossible to be used in the real world and complicated legal issues. The following relates to the previously attempted methods and problems thereof.

A service allowing, when a device touches “a near field communication (NEC)” TAG attached to a paper book, digital content related to the paper book, such as an audio book, a moving picture, and an e-book to be viewed has been proposed. However, because there are practical challenges of attaching the NFC tag to each paper book, the digital content can be provided only for the paper book buyers, and access from unauthorized users cannot be blocked, the overall quality of the service of this method is low due to the restriction of the quantity and quality of the content, which can be provided.

Patent application no. PCT/US2005/038773 discloses a method for displaying “a visual code” on a paper book and distributing the same, and making a user, who has bought the paper book, access a system and input “the visual code” displayed on the paper book such that the system allows the user to access digital content matched with the visual code. This method is the best in all aspects of the methods so far, but still has some important problems of practical challenges of generating codes as much as the number of the paper books currently distributed on the market and unavailable system access restrictions to unauthorized users (who are not paper book buyers). In other words, this method cannot help recognizing “a person who inputs the visual code into the system for the first time” as a book buyer. If a person, who is not the buyer of a particular book, acquires (borrows, rents, or steals) the particular book in some way, registers the visual code in the system, and damages (tears or punctures) this code, the system has no way of finding who has been provided with a system service with this book, and thus the system cannot find a person who expropriated the code of the book even when the real buyer of the book appears afterwards and informs that the code of his/her own book is damaged such that he/she cannot be provided with the service. Therefore, the system cannot extract the unauthorized user, and thus cannot block the unauthorized user such that the security of the system cannot be maintained.

Paper book consumers have been autonomously trying to overcome the shortcomings (portability, storage, etc.) of paper books by digitizing the paper books that they currently own. Of course, buying an e-book corresponding to a paper book is a simple solution, but for a consumer who has purchased a paper book, it is a burden to pay the same amount money as the paper book once again to get another version of the same book, and there are many cases where there is no corresponding e-book even if the customer decided to repurchase the book. Therefore, bookstores and publishers are trying to provide a corresponding e-book if customers buy a specific paper book, judging that this can increase the demand for paper books and the convenience of the users. However, this has a few intrinsic problems. If a person purchasing a paper book only keeps an e-book and sells the paper book, it's like selling two books (of different versions) for the price of one and allowing two people to share two copies of the same work. This is a significant loss for the copyright owner. Thus, the books on which such attempts are made are limited to the very few books of the copyright owners who have agreed to this. Therefore, consumers are experiencing a great inconvenience as they cannot be provided with such a service for a desired book. Therefore, some consumers who desperately demand the digitization of paper books have attempted to scan the books on their own. They are equipped with personal scanners and have done hard work, such as cutting paper books, turning pages, and so on. Accordingly, a “scan agency” appeared in the market to replace the hard work of these consumers. These agencies receive a small fee per page, and do the hard work (scan job) carried out by the paper book owner. However, these series of attempts have attracted great opposition from copyright owners because the image files they create are not protected by copyright due to the nature of the files, and they are vulnerable to piracy. Thus, in spite of much controversy, due to the protest of the copyright owners, the “scan agency” was no longer able to operate the work such that the paper book consumers have to deal with too much trouble and hassle of being equipped with personal scanners and scanning single pages of books so as to read their own books electronically.

### Detailed Description of the Invention

### Problem to be Solved

The purpose of the present invention is to provide a new distribution channel of publications to solve problems encountered by consumers who purchase paper books through existing static work distribution methods and enable them to have enhanced reading experiences. In addition to this, the present invention has a macroscopic purpose to create an ecosystem in which both paper book consumers and paper book providers can coexist by providing channels that can generate new benefits for publishers who cannot expect new demand creation from existing work distribution methods. To achieve this, the present invention has the following microscopic purposes.

The first purpose is to reduce, for a paper book owner, the time and cost consumed by purchasing the equipment individually and performing scanning or consumed by outsourcing a scan agency to get digital copying of the paper book owned by him/her, and furthermore to protect the rights of copyright owners from the risks of piracy and mass dissemination.

The second purpose is to overcome the problems of a drop in the quality and quantity of the service, caused by the existing methods, which attach and provide digital content to enable a paper book buyer to have enhanced reading experiences but are not able to provide the digital content only for the paper book buyer (or paper book owner), and of vulnerability of thereof to security risks due to unavailable system access restrictions to unauthorized users.

The third purpose is to reduce the enormous social costs of the society in order to protect the rights of copyright owners from the expected risks of piracy and mass dissemination when a paper book owner obtains digital copying of a paper book owned by him/her.

### Solution to the Problem

In order to achieve the above purposes,

the system server secures and stores digital content (for example, a digital copy, a video, mp3, other markup, etc.) associated with a specific paper book in advance, and provides the digital content associated with the a specific paper book to a specific system user who is authorized to own a copy of the specific paper book. At this time, in order for the system to identify that the specific system user owns a copy of the specific paper book, a system authenticator receives a copy of the paper book from the specific system user offline, accesses the system server, and matches the identifier information (for example, ID and a resident registration number) of the specific system user with identifier information (for example, ISBN) capable of identifying the book identity of the copy. For example, when a person (B) who owns a copy (A) visits a system authenticator offline and gives him/her a book, the system authenticator records the identifier information (for example, ID) of the person (B) and the book identity of the copy (A). Thereafter, a specific physical mark (for example, a stamp on the binding and a sticker on the cover) is made on a portion of the above copy (A), and then it is returned to the person (B). In this case, the “physical mark” is setup that announces that “this book is already a book that has been issued digital content from the system”. The reason for making such setup is to prevent that the book (A) is delivered to someone other than the real owner (for example, the person (B)) and disguised as a book that has never been issued an online service, and content is re-issued to a person other than the owner. (In other words, providing digital content associated with a specific book only to the owner of the specific book is made at the request of the copyright owner desiring to increase sales by providing good digital content for the book buyer/owner only and is to prevent copyright issues arising from the transmission of copyrighted digital content to any person. Thus, a series of steps in the system to allow digital content of a specific paper book to be provided only to the owner of the specific paper book is a requirement that must be met to achieve the basic purpose of the system.) Then, the paper book owner who has received the book A back from the system authenticator requests the system server to provide the digital content through his/her client device, the system server requests user/device authentication to the paper book owner (B) who made such request and then provides the digital content allowed to the paper book owner (B) according to the permitted usage rules.

### Effects of the Invention

According to the method proposed by the present invention,

First, the temporal and physical cost burden that a paper book owner must take by attempting to scan a digital copy of a paper book can be reduced, and the paper book owner can conveniently and easily obtain a digital copy.

Second, the risk of piracy and mass dissemination caused by paper book owner's attempt to scan a paper book can be eliminated, and the social cost for a follow-up to the spread of illegal copies online and offline.

Third, may victims who were unable to exercise their rights due to the inherent limitations of existing methods despite the legitimacy of being “someone who has the right to reproduce a specific paper book”, can be saved

Fourth, by providing a distribution channel that can provide digital content originating from paper books only for the owners of the paper books, it is possible to strictly obey the copyright law of digital content, and the copyright owner (publishers, authors, etc.) can safely attach copyrighted digital content to paper books, thereby enabling paper book owners to enjoy excellent content in both quality and quality and have enhanced reading experience.

### BRIEF DESCRIPTION OF DRAWINGS

FIG. 1 shows components according to an exemplary embodiment of the present invention.

FIG. 2 shows the role of a content provider in accordance with an embodiment of the present invention.

FIG. 3 shows a relation instance produced by a content provider and stored in a DB according to an embodiment of the present invention.

FIG. 4 shows the role of a content manager according to an embodiment of the present invention.

FIG. 5 shows the role of a right sponsor according to an embodiment of the present invention.

FIG. 6 shows the role of a system authenticator according to an embodiment of the present invention.

FIG. 7 shows an internal contract instance according to an embodiment of the present invention.

FIG. 8 shows an internal contract instance according to an embodiment of the present invention.

FIG. 9 shows a relation instance produced by a system authenticator and stored in a DB according to an embodiment of the present invention.

FIG. 10 shows a physical mark made on a paper book by a system authenticator according to an embodiment of the present invention.

FIG. 11 shows a physical mark made on a paper book by a system authenticator according to an embodiment of the present invention.

FIG. 12 shows a physical mark made on a paper book by a system authenticator according to an embodiment of the present invention.

FIG. 13 shows the role of a system authenticator according to an embodiment of the present invention.

FIG. 14 shows “a right granting table” provided for a specific paper book owner according to an embodiment of the present invention.

FIG. 15 shows a system service rendered in a client device of a specific paper book owner according to an embodiment of the present invention.

FIG. 16 shows a concept of a paper book and the book identity thereof, which are referred in the present invention.

FIG. 17 shows how the owner of a paper book hands the paper book to another person, according to an embodiment of the present invention.

### BEST MODE FOR CARRYING OUT THE INVENTION

The owner (B) of a copy (A) of a specific paper book injects the copy (A) into a machine (C), in which a system is installed, offline. The machine (C) (for example, a vending machine) requests user authentication to the owner (B) after obtaining the paper book. The owner (B) makes the machine identify an identification card, his/her fingerprint, and the like. The machine transmits the acquired information to the system server, and the system server recognizes that the owner (B) is the specific system user (B′) registered in the system and (B′) owns the copy (A). Thereafter, the system server allows system user (B′) to access the digital content associated with the copy (A). Then, the system server selects/generates “an authenticator behavior rule (D)” unique to the system user (B′) or the copy (A) and provides the same for the machine (C). The machine (C) leaves a physical mark somewhere in the copy (A) and returns the same to the owner (B) according to the received authenticator behavior rule (D). The owner (B) accesses the system server through his/her own client device, requests a system service from the system server after a user/device authentication step, and experiences the digital content associated with the copy (A) by using the service (the usage right according to the specific usage rule, access right, etc.) provided by the system.

There may be a case in which the owner (B) is “a stealer” for the copy (A) (in other words, a person who is not the owner of the copy (A), but receives the system service by renting/stealing the same and deceivingly pretending as if he/she is the owner). In such case, the actual owner (E) of the copy (A) can appear, injecting the copy (A) into the machine (C) and requesting to find out who has stolen the system service. The machine (C) requests the system server for aid and the system server informs the machine (C) of a position where the physical mark may exist with reference to the internal protocol. The machine (C) searches for the physical mark and transmits the found physical mark attribute value to the system server in accordance with the information. The system server can recognize that the system user (B′) is a stealer based on the received information, discontinues the system service provided for the system user (B′) from that point, newly registers the actual owner (E) as the owner, and provides the system service for the actual owner (E). And by pointing the owner (B) as “the stealer” and making him/her pay the penalty of law, the system-wide security is maintained.

### DETAILED DESCRIPTION OF THE INVENTION

The structural and functional descriptions disclosed in the specification are based on an embodiment that is most suitable for explaining the concept of the present invention, and one embodiment disclosed herein may be applied in various forms by a person skilled in the art. In addition, it should be noted that in order to efficiently explain the overall process of the present invention, the features (a content provider, an authenticator, a manager, and a sponsor) of the present invention are artificially distinguished according to their roles, and a specific feature may perform the role of another feature and a part of the role of a specific feature may be performed by another feature. Furthermore, in the present specification, the detailed description of technical matters which are considered to be unnecessary for illustrating the main idea of the present invention and already well understood by a person skilled in the art will be omitted. Hereinafter, the concept of terms mainly appearing in the present invention will be described first, and the overall process of the invention will be described in detail with reference to the drawings.

### 1. Definition of Terms

1-1. A Copy of a Paper Book

Most of the books that people see in libraries, bookstores, etc., are copied from various press-ready files and distributed. Such books are referred to as “a copy of a specific paper book”. Therefore, in the invention, “a copy” refers to an object that is physically handled as a unit in the real world.

1-1-1. Book Identity

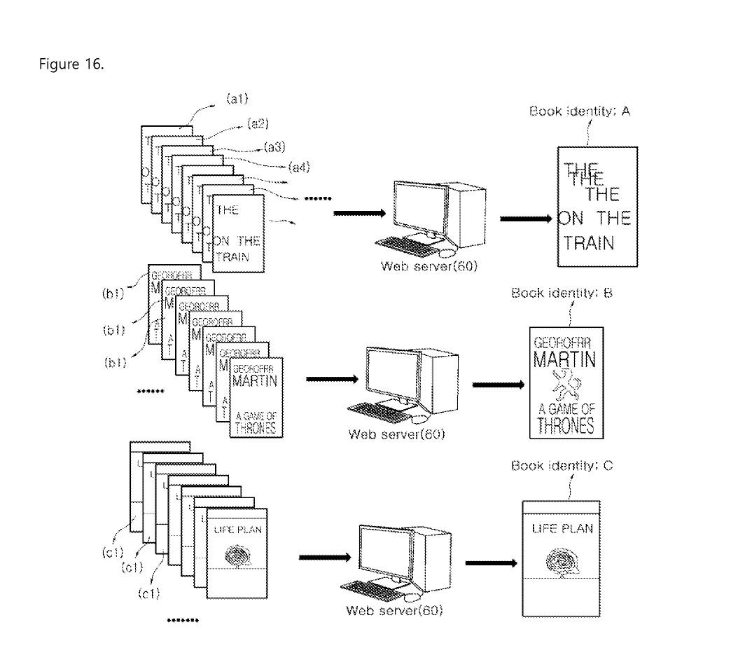

It refers to a plurality of completely identical copies in all respects, copied from a specific original file. As shown in FIG. 16, innumerable books (a1, b1, b2, a5, c1, c6, c304990, etc.) existing in the real world are copied from specific original documents (a, b, c . . . ), wherein perfectly identical books (a1, a2, a3, a4, aN . . . ) exist since they are copied from a specific original document. Although they are physically separate, they are completely identical in all aspect including book content, book authors, font sizes, line spacing, and the like. Such physically separate but perfectly identical books are treated as the same book identity in the present invention. For example, (a1, a2, a3 . . . ) in the real world are completely identical in all aspect but physically separate. However, if the system identifies them as book identity, the system identifies them with book identity A, rather than identifying them individually. At this time, a variety of information could be required by the system to identify the book identity of a specific paper book. For example, the information may be ISBN, a book title, a book author, a publication date, copyright owner, a publisher, etc., wherein ISBN corresponds to a primary key. In addition, the book identity can be identified in a variety of ways, including partial images of the paper book, indexing through extra words, and the like.

1-1-2. Book's Unique Identity

A name that uniquely identifies each of all the copies existing in the real world. In other word, the above-mentioned book identity is to treat books, which are physically separate but copied from a specific original document, as a single book without distinguishing them, whereas book's unique identity distinguishes physically separate entities and separately treats them even though they are perfectly identical.

For example, when books (a1, a2, a3, a4, aN, etc.), which are copied from a specific original document and thus are perfectly identical, are identified in the system by the book's unique identity, the system identifies each of them as a1, a2, a3, etc. The information that the system needs to identify these book's unique identities is often missing in traditional paper books. Thus, the system can separately marks these clues for each paper book in the real world and find the book's unique identity based on them.

1-2. Owner of a Copy

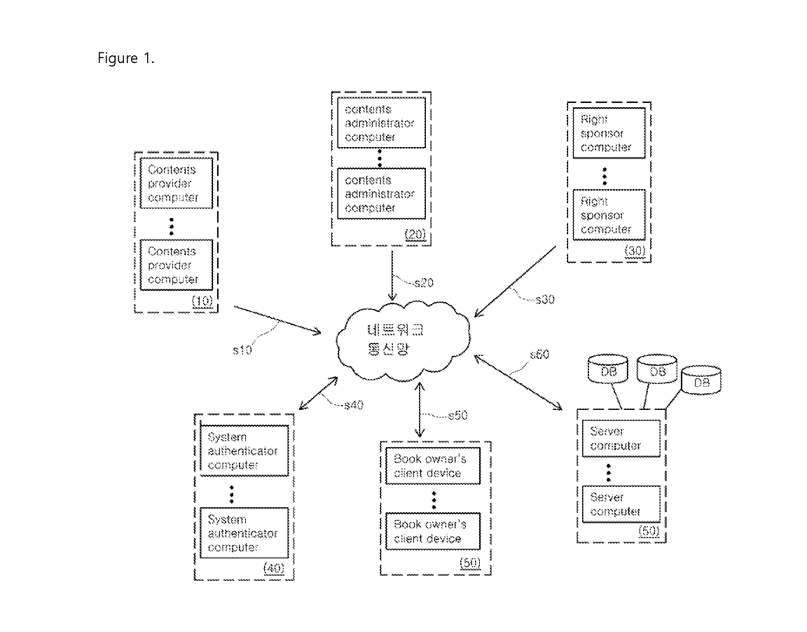

A person who has obtained (purchase, transfer, etc.) a specific copy and thus has current ownership thereof, and owns the right to reproduce the specific copy for private use as prescribed by law (FIGS. 1-50). The right to reproduce for private use means that the person, who owns a work, copies, scans, or transforms or processes the work to use it, and is allowed only when the person does not distribute it to others for profit. In this regard, according to the Article 30 of the Copyright Act, not only the actual owner who purchased the work but also the owner and the person who falls within the range of the household and its equivalent can be included, so that “the owner of a specific copy” may refer to not only the person who purchased the specific copy, but also all persons who have the same legal right as the owner (for example, family and others equivalent thereto). Within the system, the owner of a specific copy accesses the system server with system user authority through his or her client device and requests a system service from the system. In the present invention, “the owner of a specific copy” is sometimes referred to as “a specific system user” who owns a specific copy.

1-3. Content Provider

A subject (FIG. 1—10) for accessing a system server to create content and define the created content. They are those who have copyright (the right to sell and distribute) for specific digital content, who have made the content themselves or bought the copyright from the creator. The content provider further inputs a context relating to the content, and wants to show his or her content to a large number of people.

1-3-1. Content Context

One or more among “a data value” needed for the reference by a content name and content, “a related word” to be related at the time of searching, “a book name”, “the location of a book”, “a specific paragraph of a book”, and “a specific word of a book” desired to be related, “allowed operation” indicating whether user operation is allowed or not, “requirements” required for used as specific usage rules, a content category, a copyright owner, a publication date, and the like can be input.

1-4. Content Manager

It is a subject (FIGS. 1-20) that controls the system users' access to the content existing in the server in the system. They specify the condition of a user who can access specific content and the condition that the access permitted user requires to use the same as specific usage rules.

These may be software programs, possibly reflecting system operation policies and/or content provider requirements, which when requested by system users, utilize the context information collected by the system to select content appropriate for the user.

1-4-1. System Context

1-4-1-1. Paper Book Context

The system can grasp the book identity of a specific paper book owned by a specific system user and information related thereto by grasping the identifier (for example, ID) of the specific system user through a client device.

1-4-1-1-1. External Context of a Paper Book

Identification information that describes a paper book in the real world, such as the publication date of a document, a book title, an author name, ISBN, a publisher, the category to which a book belongs, and a circulation

1-4-1-1-2. Internal Context of a Paper Book

Features that are indirectly/mechanically identified rather than directly identified to the user by the physical size of the paper book, the font size of the letters printed on the paper book, line spacing, and other layout information.

1-4-1-1-3. Content of a Paper Book and Information Associated Therewith

The content of a paper book and information associated therewith. For example, background knowledge about a person mentioned in the book, dictionary meaning of the word in the book, etc.

1-4-1-2. User Context

Obtained Information on a Specific System User Requiring a System Service Through a Client Device

1-4-1-2-1. Context for the History of Interacting with a User System

It relates to the history that a user interacts with the present system. This may be created by adding extra fields (for example, a book identity identifier, a user identifier, location on digital identity, time of day, etc.) when a user runs a specific action, and corresponds to any information, that the system can detect, including a history that a user has logged in by the system, the time a user spent in a specific book, and the like.

1-4-1-2-2. Real World Context of a User

The age, geographical location, serial numbers of other devices, mobile phone communication history, and mail transmission/reception history are collectively referred to as information that can identify user's activities and personal identity.

1-4-1-2-3. Related Digital Context

It collectively refers to digital document browsing history, a file identifier attached to a mail, the search word input history of a search engine, online purchase history, and advertisement listening history.

1-5. Right Sponsor

A subject (FIGS. 1-30) that helps a specific user in meeting the requirements for using specific content by a specific usage rule. They have the right to sponsor a right for a specific system user from the system by accessing the system by the authority of a right sponsor through a separate authentication process. Innumerable digital content in a DB shall limit the indiscriminate access/use from a random system user and provide limited content experience in accordance with the usage rules specified to a user authorized by the content provider/administrator. At this time, in order for a specific system user to have the authority to use specific content by specific usage rules, the specific system user is required to satisfy the requirements specified by the specific content provider. A “right sponsor” helps the user in meeting these requirements. They select the objects (users) they want to sponsor, and sponsor some or all of them to meet their requirements.

1-5-1. Right Sponsor in the Real World

1-5-1-1. Persons Concerned with the Sale of a Specific Paper Book

The system may allow the role of a “right sponsor” to be the “persons (for example, copyright owners, publishers, and on/offline bookstores) concerned with the sale of a specific paper book”. They want to attract buyers with the content associated with the book and increase their book sales revenue. A subject who benefits by selling a specific book tries to increase the book sales revenue by providing “digital content” as a free gift added to the specific book for the same reasoning as an owner of a mart, who sells an article (A) with a free gift so as to sell more articles. Buyers are likely to feel a greater need for a book that offers some form of benefit over a book that has nothing added. However, at this time, since “digital content” is an intangible “service” experienced by users rather than a physical article such as the above-mentioned “free gift”, when such “service” is to be provided as a free gift, a “Right” should be given.

For example, some publishers induce a main selling product to be sold more than other books by offering some free content (v) which is quantitatively/qualitatively superior to other books to a person who has purchased a specific paper book (for example, ISBN-203040556) selected as the main selling product. In addition, online/offline bookstores (for example, amazon.com) promote that the paper book is provided with the right to browse other content in addition to the above content (v) free of charge, thereby inducing consumers to purchase the paper book at their bookstores. Alternatively, online/offline bookstores promote that they offer buyers who buy books through their bookstores at a certain period of time (for example, 10 to 12 am on March 10) with a variety of benefits (coupons, cash, discount coupons, vouchers, other rights, etc.) for content stored in the system and promote sales of books. In addition, second-hand bookstores can sell out books in stock, that they want to dispose quickly (for example, physically damaged books), prior to other books by promoting free access to specific content.

1-5-1-2. Subject Who Wants to Give a Specific Benefit to a Specific Person

There may be individuals who want to give benefits only to those who meet certain requirements. For example, if there is a professor who wants to provide specific content (note-taking and related electronic documents) at a discounted price for students taking his/her class, the professor can request the system to give benefits (discounted price) that he/she wants to give only to “students who take a certain class”. The system, in response to such request, selects users who meet the condition of “students who take a certain class” among the users of the system and gives the benefits requested by the sponsor to them.

1-5-1-3. Advertiser

The system may allow “advertisers” to act as “rights sponsors”. The advertiser specifies the content to be associated with himself/herself or specifies the condition of the content to be associated, such as the number of times of exposure and the like, and can sponsor a part or all of the requirements for a person who watches his or her advertisement.

1-5-2. Form of Sponsorship

In accordance with system operation policies, a right sponsor may sponsor a specific user in various forms. They help a specific user meet the requirements for experiencing specific content. Although the requirements may vary from content to content, they can generally provide subsidies, coupons, accumulated money, and a sponsor free pass for all content.

1-6. System Authenticator

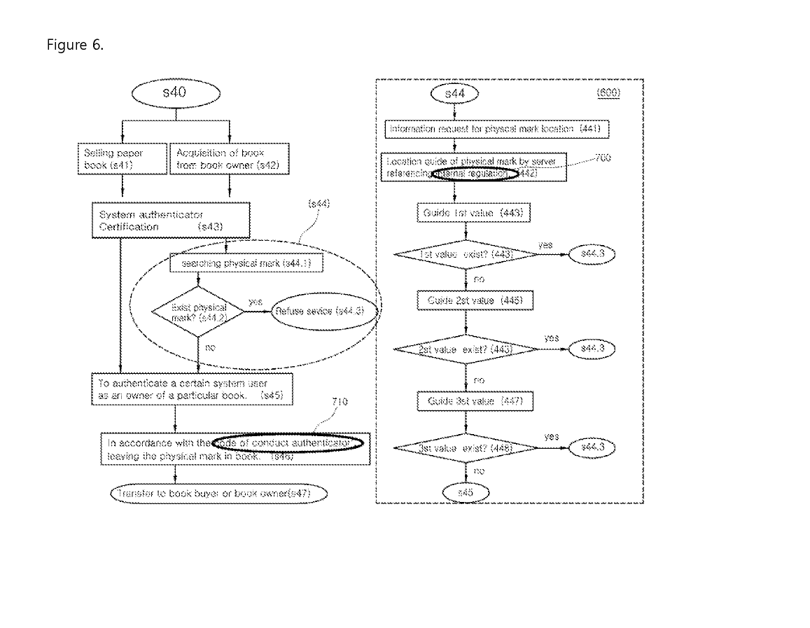

It is a subject (FIGS. 1-40) that authenticates a specific system user as an owner of a specific paper book and makes a physical mark on the specific paper book and transmits the same to the specific system user. Such a system authenticator may be the operator of the system (person in charge), a person contracted to perform this role (for example, a convenience store employee, an online/offline bookstore staff, etc.), or a machine programmed to perform this role, wherein a program set up to automatically notify the system of the information required by the present system when purchase/payment is made to an online bookstore can be an example. For the role of the system authenticator, see the description of FIG. 6 of (ch2). In addition, it should be noted that each of the “system authenticators” mentioned in (a)-(c) in claim 1 may be actually the same subject, or may be different subjects.

1-7. Client Device

A device used by a specific paper book owner to access online services of the system, and is connected to one or more system servers through a communication network. The communication network may be an integrated intranet, the Internet, a mobile phone network or some other network, or an interconnection of the same, and the client device may be an Internet-enabled mobile phone, a PDA, an onboard computer, a network computer, an Internet tool, or a wireless IP-enabled device and is preferably connected to an internet network and has a system application installed therein. The connected server is a web server, and the system service is started when the client device accesses the system application and requests a specific service. Preferably, the client device described in this specification may be limited, for copyright protection, to devices that are authenticated (for example, account login, device serial number check, etc.) from the system that the owner of a specific paper book uses or owns.

1-8. System Server

Functionally, there are a digital content server for storing and responding to digital content corresponding to a specific paper book, and a licensing server for checking access right to specific content. The licensing server stores membership information of system users, payment/settlement information of system users, content usage rules specified by content providers, and the like, and issues a right for specific digital content to a specific system user at the request of a right acquisition sponsor. Thereafter, in response to the request of the client device, which has completed user/device authentication, the digital content that can be provided to the user is DRM-equipped according to the usage rule given to the user and is provided to the user.

1-9. Digital Content (a Book's Digital Counterpart)

In the present invention, the digital content collectively refers to digital data that can be corresponded (associated) by identifying, by the system, the book identity of a specific copy. Let's look at the types of digital content that the system can provide to users, how to obtain the right to use digital content, and security policies to protect the copyright of digital content. The following description is merely an embodiment for understanding the present invention, and all other embodiments that can achieve the object of the invention should be included in the scope of the present invention.

1-9-1-2. Digital Copy

A press file (film or quark used in printing through a printing shop, or an InDesign file), or an image file obtained by scanning each page of a copy offline by using a scanner.

1-9-1-3. Multimedia Materials

Multimedia data that the system can provide in association with a specific paper book. These may be video, audio, text/document, image, graphics, etc., may be associated with an entire specific paper book, a specific page of a specific paper book, and a specific object in a specific pate (semantic units: for example, words, sentences, and paragraphs), and has a main purpose of providing a user with enhanced reading experience by providing complementary electronic information to a specific paper book.

1-10. Online Service of the System

An online benefit that is given to a specific system user who owns a copy of a specific paper book so as to allow him/her to use digital content associated with the specific paper book. The benefit is to give the user a right to access/use the digital content or to give the user the opportunity to have a right. In order to provide specific materials to a specific person in the physical world, a simple delivery of materials is enough, but in order to provide specific persons with materials that exist in a digital form online, a “right” to use materials is given to a specific person so as to make an unauthorized user unable to use the materials and restrict the access of the unauthorized user. Accordingly, once the system identifies that a specific system user has owned a specific paper book, the system should provide the specific system user with a “rights” to access/use digital content associated with the specific paper book.

1-11. Digital Right Management (DRM)

Digital content whose usage rules are specified should be provided to users in order to comply with the usage rules. A technique for this is generally referred to as DRM. In general terms, “DRM” collectively refers to technical elements distributing content such that the rights of digital content owners and the specified rights are protected. In other words, in the present invention, “DRM” collectively refers to means achieving the purpose of this system (preventing piracy and leak of digital content). That is, in this system, “DRM-equipped digital content” refers to digital content having technical elements making digital content used according to the usage rules specified for specific content of a specific system user. That is, DRM can be defined as a technique related to management of electronic content and related intellectual property rights and distribution of content. To this end, DRM technique is used for the identification, description, access restriction, copy restriction, usage control, accounting (measuring the usage time and amount to calculate fees according to usage), billing, monitoring, and tracking with respect to electronic content.

A DRM process begins in earnest when a copyright owner or a content provider converts a media file into a protected media file. This conversion process is performed by applying a protection technique such as encryption or watermark, and is associated with content usage rules. The content usage rules describe in advance how to use the content. The content in which the usage rules are described is delivered to an end user according to various content distribution network models (Internet, offline, broadcast, etc.). Since the protected content is not available without a right to use the same, the end user requests the right to use after paying a right provider or meeting other requirements for right request. This usage right is often referred to as “authority” (license), and the right provider operates an authorization server for providing rights. The authorization server issues a certain type of authorization to an authorized user who has undergone appropriate rights checking after user authentication. Users who get these licenses may experience limited content in accordance with the usage rules described.

1-11-1. Content Identification

In the analog world, all content has a name. However, because it is not possible to identify the uniqueness of the content by name alone, the system manages the content through a unique identification scheme. So, why is this identification system included in the core elements of a DRM technique? This is because content protection starts with the system correctly identifying an object to be protected (digital content). In other words, this is an essential element for content identification and copyright management (ownership, usage right, distribution information, etc.) in the content distribution process.

1-11-2. Right Expression

A content provider specifies content usage rules while posting and uploading specific content. That is, the content of the contract for the requirements concerning operation (storage, browsing, copying, etc.) and the right to use the content are specified.

1-11-3. Encryption.

When copyrighted content is distributed, “security” will be the factor that is most considered by a provider. Currently, the security relies heavily on encryption technology. Encryption is a basic tool used to make content sources into protected content. Also in the present application, it is desirable that the digital content is kept secure through encryption, and such a cryptosystem fundamentally prevents piracy and illegal circulation and thus is more secure than the watermarking system.

1-11-4. Packaging and Key Management

Conversion of original content into protected content is called “packaging”. Packaging refers to a process of configuring a secure container, which is an electronic security device used for distribution by associating information related to content protection and distribution such as content, metadata, and distribution rules, with the original content subject to copyright protection. Packaging involves encrypting content and metadata by using an encryption key and digitally signing. Packaging itself may vary from agency to agency, making it difficult to standardize and describe. To control access to content in a DRM system, normal content is encrypted and transmitted and a key used to encrypt the content is passed to a user through a license. Therefore, the generation, distribution, and management of content encryption keys are the most important part of security, and this part is one of the difficult parts to standardize because it has been developed in a way unique to DRM agencies.

1-11-5. Authentication

In order to judge whether a user or a device requesting access or use of protected content is allowed for a request action, it is necessary to first identify who the requestor is.

At this point, an authentication mechanism is involved.

The protected content is determined in terms of authentication, usage rights, and usage conditions for the object to be used in the authorization process, and this is implemented in the form of a specific license.

In this system, authentication may be canceled by user authentication alone. However, in order to securely protect copyright, it is desirable that the system simultaneously requires user authentication and device authentication.

Let's look at the ID/PW method. In the case where one user uses multiple devices, the ID/PW method does not need to employ a separate authentication mechanism for each device, and thus the system-wide authentication is simple and on the user side, there is an advantage that usage is transparent. However, there is a problem that the ID/PW is shared between users who do not have permissions to access such that in order to compensate for the problem, a device authentication process is further needed. Such device authentication (s52) may be performed in various ways depending on the purpose, wherein a user may register and activate a device used by the user at the time of initial use, and a method of recording a MAC address or a hard disk serial number is also available. In this system, it is desirable for the purpose of the system to limit the number of devices that the user who has passed the user authentication process can use. Preferably, it should be limited to two or three devices (for example, smart phones, tablet PCs, and PCs) to eliminate the possibility of ID/PW being shared and distributed. In some cases, the device may be authenticated after confirmation on whether the device is owned by the user (whether the requested device serial number belongs to a person legally owning the same) is made. Such device authentication will depend on the security policy of the system, but for smooth use of the system, it is desired that the system limits the number of devices that can be used with a specific ID, authenticates the actual owner of the device, and when the device is lost, the device can be erased and other device can be registered such that the system user can use the service without an interruption caused by the replacement of the device.

1-11-6. Copy Protection

If content equipped with DRM is illegally copied in a device or a transmission medium process, it is necessary to prevent copying because DRM is successfully bypassed. Copy protection technology is a technique used to prevent piracy of digital signals transmitted between devices. Examples include CSS, AACS, and OpenCable's POD Copy Protection Technology.

1-11-7. Watermark

A digital watermark refers to a technique for inserting a code such as an ID or information, that can be known only to a user, to digital content, or inserting a specific code or type into a video or audio signal. This is also a technique for preventing piracy and effectively protecting the copyright and ownership of data owners. This digital watermark has an advantage that it is very effective in detecting the origin and the reproduction path of the original without hindering the user from viewing the file or using the software at all. However, the digital watermark cannot fundamentally prevent reproduction and is merely a post-treatment.

1-12. Internal Protocol

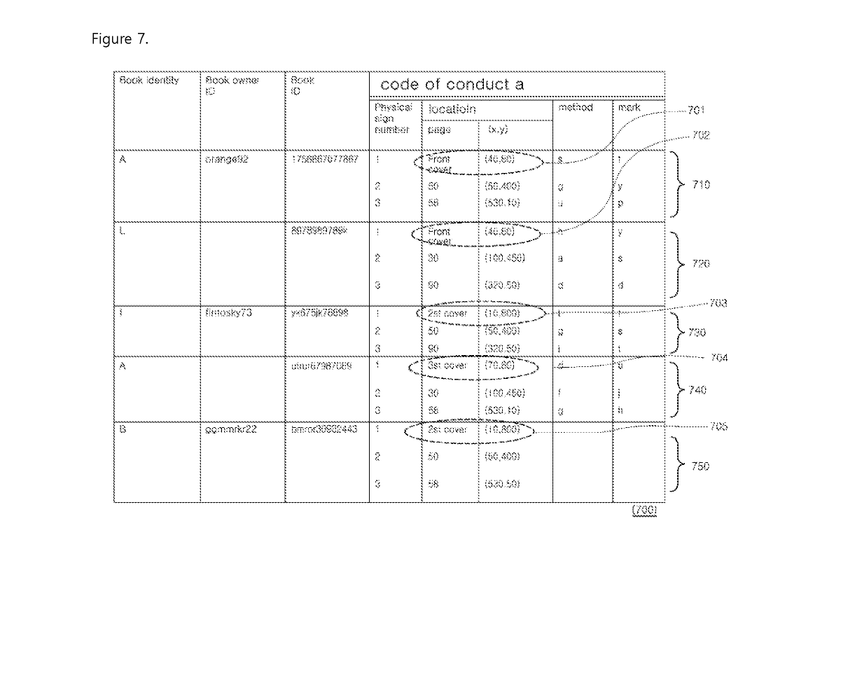

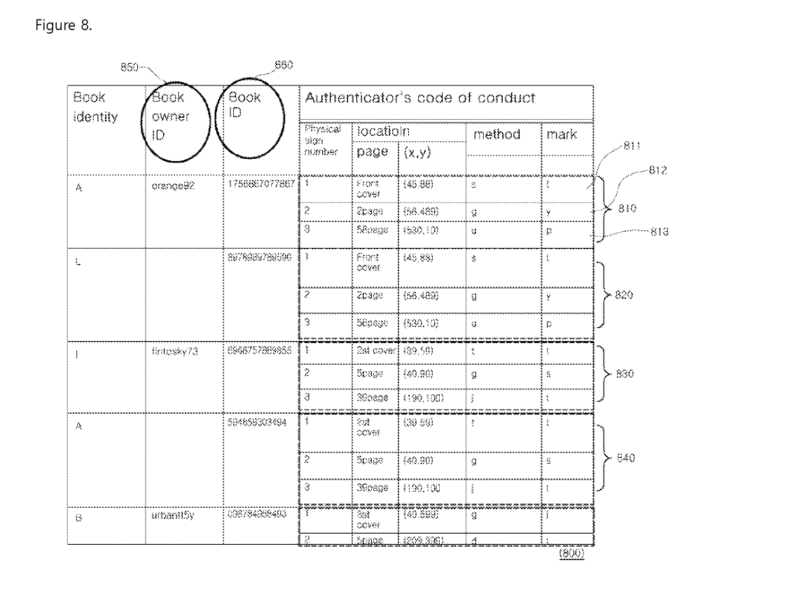

The internal protocol is like a rule that system authenticators should follow, and is a kind of “promise” that is shared among system authenticators. In other words, the internal protocol relates to “where to make a mark on a copy” and is a rule that the system authenticators must follow. If there is no such rule and an authenticator (x), who should leave a physical mark in a copy, makes a physical mark here and there, an authenticator (y) cannot perform determination work because the authenticator (y) does not know where the physical mark is located by the authenticator (x). Therefore, the system should present a rule that the authenticator (x) should follow, makes the authenticator (x) make a physical mark according to the rule, and lets the authenticator (y) know the rule so that the authenticator (y) can find the physical mark by referring to the rule. In the present invention, an instruction presented to each system authenticator by such an internal protocol is called an “authenticator behavior rule”. Primarily, the authenticator behavior rule will be presented in the form of “Leave a certain mark at a certain location”. In other words, the overall rule, in which what kind of “authenticator behavior rules” should be presented to the authenticators in accordance with the system operation policy prescribed and stored in advance, is referred to as the “internal protocol”, and an “individual” rule presented to each authenticator according to the “internal protocol” is called the “authenticator behavior rule”. That is, the cumulative history of the “authenticator behavior rule” is the “internal protocol”. As shown in FIG. 7, the internal protocol (FIG. 7—700) can be regarded as a table (relation) composed of a tuple called an “authenticator behavior rule” (FIG. 7—710, 720, 730, 740 . . . ), wherein each tuple guides “physical mark(s)” to be made by an authenticator. (FIG. 8—800) is an internal protocol instance according to one embodiment. (FIG. 8—810) is an “authenticator behavior rule” consisting of three physical marks (811, 812, 813) and (811) indicates a first physical mark.

The internal protocol that reflects the system operation policy is implemented in each copy at the actual level by the “authenticator behavior rules”. The internal protocol can realize various functionalities in the real world according to the own features. Let's look specifically at what functionality within the system will be performed according to the features of the internal protocol. Let's take a look at the features of the internal protocol, and the functionality according to the same, by applying the internal protocol as a table and “authenticator behavior rules” as tuple. The internal protocol may have one or more features listed below.

1-12-1. The “Authenticator Behavior Rules” May be Learned in Advance.

There may be an internal protocol that have the same “authenticator behavior rules” (same tuple) collectively for all copies in the real world. According to this internal protocol, authenticators may repeat the same behavior on all books (for example, setting a seal of the company to the top binding on a book) without distinguishing copies. An internal protocol having such a feature can be easily understood by an authenticator in advance, and thus can be implicitly understood without being stored separately on a system server.

1-12-2. The “Authenticator Behavior Rules” can be Instantly Presented by a System Server which Responds to the Authenticator's Request.

Since the authenticators cannot easily understand such an internal protocol if the internal protocol is not in a monotonous and simple form such as (ch1-12-1) described above, the system server should inform the authenticator behavior rules whenever a request is made by authenticators. Thus, the internal protocol referred by the system server can be made into a somewhat complicated form and can be guided to each authenticator, thereby realizing a wide variety of functionalities.

1-12-3. An “Authenticator Behavior Rule” May Include a Plurality of Physical Marks.

The “authenticator behavior rule” provides a plurality of physical marks to prepare for damage (tearing, breaking, and scribbling) to the physical marks. In addition, in one embodiment, a combination of attribute values of a plurality of physical marks may indicate the uniqueness of the authenticator behavior rules. As shown in (FIG. 8—810), the “authenticator behavior rule” stored in the table as (810) indicates that “a first physical mark indicates t by a method s at the position of a front cover (45, 88), a second physical mark indicates y by a method of g at the position of page 2 (56, 489), and a third physical mark indicates p by a method u at the position of page 58 (530, 10)”.

1-12-4. A Physical Mark May have Extra Attribute.

The physical mark presented by the “authenticator behavior rule” may have an extra attribute value such as a “position” means “sign”.

1-12-4-1. Position

A “position” attribute may additionally have a secondary relation to page number, coordinates, and the like.

1-12-4-2. Means

It refers to a method used when making a physical mark. For example, anything that is marked on the copy, such as puncturing, tearing, cutting, stamping, sticking, etc., to leave any physical traces can be a means.

Standardization of Means

It is preferred that the system pre-distributes the means by which a specific sign is marked (for example, a sticker on which a specific pattern is printed, and a stamp on which a specific sign is marked) to the system authenticators, names each of them (for example, sticker 1, sticker 2, stamp 1, and stamp 2 . . . ), and defines what each name refers to. This work is called “standardization of a means”. The standardization of a means induces uniformity throughout the system, and facilitates a fast work process.

1-12-4-3. Sign

If the above-mentioned “standardization of a means” has not been accomplished, the system authenticator behavior rule should additionally have “sign” attributes so as to specifically indicate what to mark by the means presented. The signs may be arbitrary single patterns such as &, *, %, #, !, and the like, a combination of numbers, alphabets, numbers+alphabets, etc., or barcodes, QR codes, etc. which are mechanically identified, or could be autonomously created by the system on each occasion in reference to texts or images printed on a book.

1-12-5. The “Physical Mark” can be Made at a Specific Position Pre-Selected by the System.

If the position of the physical mark is different for each copy, the system authenticator is not able to find where the physical mark is, so the “position” attribute value of the “physical mark” should be a value selected by the system.

1-12-5-1. In the Case in which there are a Plurality of “Physical Marks”

If an “authenticator behavior rule” includes a plurality (n) of physical marks, the system assigns order numbers to the respective physical marks, and the physical marks, in each tuple, having the same order number may have one of values pre-selected by the system. For example, if the system selects a, b, and c as the “position” attribute value of the first physical mark, then the first physical mark of each tuple should take one of the values a, b, and c. For easy explanation in reference to FIG. 7, (FIG. 7—700) shows the “internal protocol” composed of an “authenticator behavior rule” having three physical marks. Each of the authenticator behavior rules (710, 720, 730, 740, 750) comprises three physical marks. At this time, the location attribute value of the first physical mark of each tuple takes one of the values (701, 702, 703) pre-selected by the system. In this case, the value selected in advance as the position value of the first physical mark is referred to as 1st key in the present invention, and the value pre-selected by the system for the second physical mark and the third physical mark by the same principle is 2st key and 3st key, respectively. If the 1st key is 2, the 2st key is 3, and the 3st key is 4, the system authenticator may have to make determination on whether there is a physical mark a maximum of 2×3×4 times.

1-12-6. The “Authenticator Behavior Rule” can be Unique to a Specific System User or a Specific Paper Book.

1-12-6-1. The “Authenticator Behavior Rule” Unique to a Specific System User

The internal protocol may assign an “authenticator behavior rule” unique to a specific system user. As shown in (FIG. 8—800), a specific system user (for example, orange92) assigns the same authenticator behavior rule (FIG. 8—810, 820) to copies that he/her owns, and another specific system user (for example, fintosky73) assigns the same authenticator behavior rule (FIG. 8—830, 840) to copies that he/her owns. That is, a unique “authenticator behavior rule” is assigned to the books owned by a specific system user, wherein the authenticator behavior rule is distinct from that assigned to other users. According to this, the copies (differentiating from the copies owned by other system users) owned by a specific system user will have the same physical mark as, and in other words, this physical mark will be used as a “code” for identifying the specific system user in the system. If an owner claims that he/she has not been issued a service as somebody stole a book that he/she owns and has received a system service, the system identifies the “physical mark” made on this book and makes the server identify the same such that a “stealer” can be easily found and a service is discontinued, thereby maintaining the security of the service.

1-12-6-2. The “Authenticator Behavior Rule” Unique to a Specific Copy

The internal protocol may assign a unique “authenticator behavior rule” to each physically separate paper book. In other words, the physical mark left in the copy according to the “authenticator behavior rule” is used as a code for identifying the book's unique identity of a specific copy in the system. (FIG. 7—700) indicates that 710≠720≠730≠740. According to this, each copy has a unique “physical mark”. The system can identify a “stealer” by matching the “authenticator behavior rule” presented in accordance with this internal protocol with the identifier (for example, ID) of a specific system user who owns the copy, and it is advantageous to the system in many ways because the system can simply change the name of the owner even if the owner of the specific copy is changed.

1-12-6-3. How to Reveal Uniqueness

The “authenticator behavior rule” can reveal the own uniqueness in various ways. Here are some embodiments.

1-12-6-3-1. Uniqueness to be Revealed Through Specific Signs

It is possible to unify the value of the position attribute of each tuple, and shows the uniqueness with the attribute value of the “sign” attribute. This means that the “position” attribute value of the internal protocol is common, meaning that something is marked at the same position of the actual copies. Therefore, to represent uniqueness with these physical marks, all information should be implicit in the “sign” attribute value. The “sign” can directly or indirectly (mechanically) show information indicating the owner of a specific paper boo or the uniqueness of a specific paper book.
Direct mark—system ID, an email account, a resident number, a unique serial number of a specific paper book, and the like
Indirect mark —a mark which can be distinguished by being identified in the system. For example, special patterns (bar codes, QR codes, etc.), combinations of alphabet and numbers

1-12-6-3-2. Uniqueness Revealed Through Specific Means

It is possible to indicate uniqueness by collectively marking a paper book with a specific means (for example, a stamp engraved with a specific pattern, stickers, and puncturing a specific pattern) previously selected by the system. However, if the paper book is left with a physical mark with a unique position value, it is difficult for a system authenticator to find the same, so it is desirable that this “position value” should be limited to the specific coordinates of a specific page/specific page selected by the system. However, the limitation on the position value may cause a limitation on a wide range of cases. To this end, the present system proposes the following method.

1-12-6-3-2-1. Change in Direction/Inclination

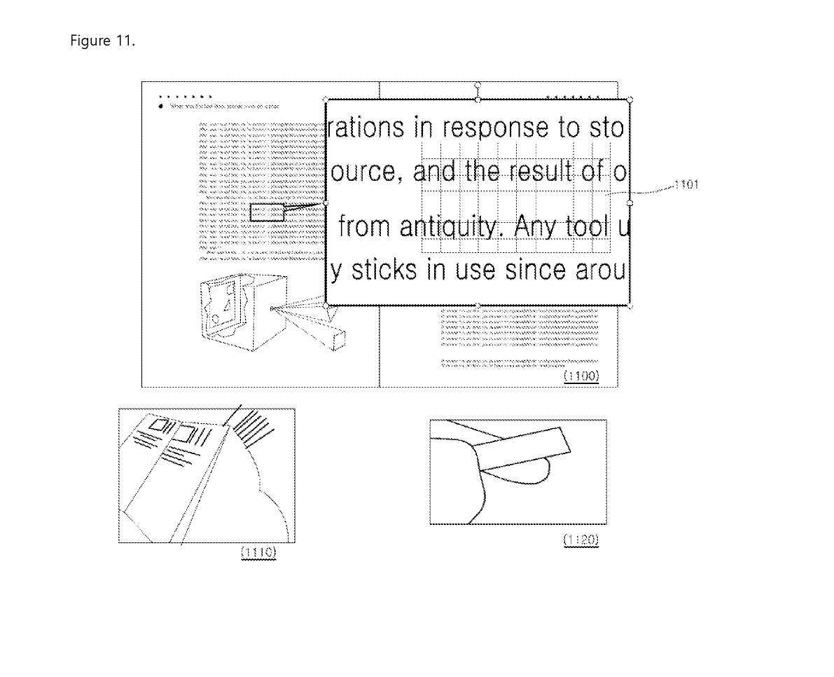

a stamp (FIGS. 11-1110 and 1120) engraved with a specific pattern/sticker is marked at a position (specific page, specific area) selected by the system, wherein the direction and inclination thereof change such that the entire page is irradiated (for example, capturing) by a specific device.

1-12-6-3-2-2. Harmony with Print

There is also a method of revealing the uniqueness by marking a sticker on which a specific pattern is engraved so as to overlap with a printing area (a portion where letters or figures are printed) of a paper book (FIG. 11—1100). At this time, since such a sticker overlaps the top of the printing area, it is preferable that the sticker has penetrability (transparency/semi-transparency) so as not to interfere with the user viewing the book, wherein having penetrability means that the printing area of the book screened by the stamp/sticker is visible to the human eye and it should be noted that the stamp/sticker is not necessarily as transparent as glass to a specific pattern. For example, (FIG. 11—1101) shows that a sticker (1101), to which a lattice pattern is engraved, overlaps some area. At this time, the lattice pattern is engraved on the inner side of the sticker, wherein the pattern is perceptible to the human eye, or is not perceptible to the human eye but could be mechanically identified. Even though the pattern is perceptible to the human eye, it does not matter as long as the pattern does not interfere with viewing the printing area, as in the case of (1101). In addition, a specific pattern engraved in the sticker (for example, a lattice pattern) is physically engraved inside the sticker to protect the pattern from damage (scribbling and writing) so that even if someone scribbles or writes on the sticker, these (scribbling and writing) can be easily erased from the sticker and the specific pattern engraved inside the sticker is preserved. The physical mark from an addition (scribbling) has been removed will be uniquely identified by the system as it is imaged with the printing area and transmitted to the system. That is, the image at this time will be a pixel value in which the specific pattern engraved in the stamp/sticker and the printing area beneath the same match up.

1-12-6-3-2-3. Uniqueness Represented by a Combination of Attribute Values

When there is a plurality (n) of physical marks, the system may exhibit uniqueness as a combination of attribute values of these physical marks. There is an embodiment of various methods for this.
Prior to the explanation of method, the names that appear will be defined. Assign the physical mark of each tuple to an order number, and denote the “position” attribute value of an Nst physical mark as an Nst key. That is, the set of the “position” values of the first physical mark in each tuple is called a 1st key, and the set of “position” values of a second physical mark and a third physical mark of each tuple is referred to as a 2st key and a 3st key, respectively. Note that the Nst key is pre-selected by the system, and could be configured in a single or plural form. Each of the elements of the Nst key is called “Nst key N”. If the elements of the 2st key are three (a, b, and c), a is 2st key 1, b is 2st key 2, and c is 2st key 3. At this time, it should be noted that Nst key may refer to a specific page or a specific coordinate of a specific page.

1-12-6-3-2-3-1. A Combination of mCn

In preparation for situations where physical marks are not properly identified by the system as a result of being damaged (torn, scribbled, etc.) by the user, the system leaves m physical marks in a specific copy, and when any n of them are extracted, their combination of attribute values can be unique. For example, when an authenticator left seven physical marks in a specific copy and five of them were damaged by the user, the system can determine a unique tuple by only using the attribute values of the remaining two. Note that m and n may be one or more.

1-12-6-3-2-3-2. End-to-End Feedback.

It is a method of grouping a specific Nst key N and a specific (N+1) st key N. For example, if a specific tuple has the 1st key 1, it must have one among 2st key 3, 2st key 4, and 2st key 13, and if it has 2st key 3, it must have one among 3st key 5, 3st key 6, and 3st key 17. If Nst N is uniquely identified to the system itself, it is very convenient for an authenticator to perform “determination on whether there is a physical mark” or to determine “uniqueness” by only searching the 1st key. However, if one of the 1st keys is damaged, the authenticator must be informed of the “position of a physical mark” to be searched later on through end-to-end feedback with the server. For example, if the authenticator informs the server of “1st key 1=damaged, 1st key 2=absent, and 1st key 3=absent”, the server first drops all tuples having 1st key 2 and 1st key 3 as the 1st key in the internal protocol. Then, if the tuples with 1st key 1 as the 1st key value are aligned, these tuples' 2st keys are guided to the authenticator so that the authenticator can search them. When the authenticator searches for them and notifies the server of the result again, the server aligns the tuples in the same manner as before and presents the next key to be searched by the authenticator. According to this scheme, the search process to be performed by the authenticator can be very simplified.

1-12-7 Physical Marks May be Made by a Means that is not Easily Damaged.

It is preferred that physical marks are not easily damaged when somebody damages (tears, scribbles, erases, etc.) the same. For example, they can be made by setting a seal which does not come off easily, attaching a sticker which does not easily come off or does not badly damage a paper book when coming off, or punching holes in a certain shape. This is to enable a system authenticator to easily recognize whether or not the physical mark is damaged even when the physical mark is intentionally damaged by somebody, by leaving traces therefrom. If the physical mark is erased by a person with ill intentions, without leaving any traces, the system authenticator may misrepresent that the physical mark does not exist in the first place and re-issue the online service. Therefore, the system should be prepared for the approach of a person with ill intentions by marking it as a means that is not easily damaged, or as a means of leaving traces even if it is damaged. For example, there is a seal that spreads in a print when erased, or a sticker that tears with paper when removed.

1-12-8 Physical Marks can be Hidden and Marked

If the physical mark is easily found by a user, the physical mark may be damaged by a random person with ill intensions, causing a failure in the operation of the system. Therefore, physical marks can be hidden and marked so as not to be easily found by a user.

1-12-8-1. Invisible Position

It can be concealed by being marked at a position where the user is difficult to browse, somewhere on the folded paper or the front cover.

1-12-8-2. Means That Are Only Mechanically Identified

It can be marked by a means that is not easily visible to the naked eye initially, but is identified only by a specific mechanical device. For example, by stamping with an ink made of invisible carbon or by attaching a transparent/semi-transparent sticker, in which an invisible component is thinly distributed, it is not easily visible to the naked eye.

1-12-8-3. A Sign that is Difficult to Distinguish from a Book

It is perceptible to the human eye, but when marked in a paper book, it is seen as a part of the content of the book (i.e., printed at the publishing stage), and thus it is hard to distinguish whether the sign is artificially added by a system authenticator afterward. For example, a specific word, a specific period, or the like is thickly marked or a specific word is putted in brackets or is underlined. These signs can be generated by a specific program in the system referring to an electronic copy (scan image) of a book held by the system.

1-12-9. The Physical Mark can be Used as a Clue to Check Ownership of the Registered Owner of the System.

If a person receives a system service from a specific paper book, then transfers the paper book to another person (changing the owner) may cause copyright issues. In other words, the online service provided by the system should be provided only to the owner of a specific paper book. If, as in the situation described above, if the owner of the paper book and a person who receives the online service is different, it is a violation of copyright law because it is an online service issued to a non-owner. Suppose, for example, that a person A has received an e-book (B′) from a system (B) with a book B. However, as soon as this person had issued with this e-book, the person sold the book B to a person C such that the person C became the owner of the book B. However, the person who is currently holding an e-book from the system is the person A. In this situation, with respect to one book, one person owns an e-book and the other person owns a paper book, in other words, a person who is not the owner of the paper book becomes the owner of the e-book. To prevent infringement of copyright, which may be caused by the above, the system checks whether the person A continually owns the book B, and once the system determines that the person A does not own the book B, the system should stop the supply of the e-book B′. To achieve this, the system can request the person A to let the system identify the physical mark made in the book B at a specific point of time or unexpectedly. The person A lets the identification of the attribute value through his/her own client device in response to the monitoring by the system. Then, the system receives the information, checks whether the client device is an authorized device for the person A, and determines whether the information transmitted through the client device matches the information stored in the system. At this time for the person B, in order for this purpose to be successfully achieved, the physical mark must meet several requirements:

1-12-9-1. Identification Only by a Mechanical Device

The physical mark shall be obtained by the user by means of an optical mechanical device provided in the client device. If a physical mark can be entered and transmitted based on a keyboard, the person A will contact the person C to ask for the physical mark and can input the same through his/her keyboard by disguising that he/she still owns the book B even after the person A has sold the book B to the person C.

1-12-9-2. Transmission at the Same Time as Acquisition

The physical mark must be transmitted to the system at the same time as the acquisition thereof by a mechanical device provided in the client device. If it allows anything already stored in the memory of the client device, the person A can separately acquire (capture) the physical mark before selling the book B to others, and send the image stored in advance at a request of the system so as to avoid the inspection of the system. For this purpose, it is preferred that “an application set such that a mechanical device drives to acquire an image and transmit the same to the system server at the same time” is installed in the client device of each user, thereby allowing the users to utilize the same.

1-12-9-3. Reuse Prevention

Physical marks should be made to make reuse difficult. If the physical marks are easily separated from the copy and reusable, the stealer can bypass this inspection as long as the above requirements are met. For example, before the person A sells the book B to the person C, if the person A cuts out a portion in which a physical mark is left in the book B and responds to the subsequent inspection of the system with the same, the system can be easily deceived. To prevent this, the physical mark must become non-reusable at the moment when it is separated from the book B (for example, a sticker which is badly damaged when removed from a copy) and significantly lower the quality of the book B when cut out (for example, overlapping an important part of the text of the book, . . . ), thereby preventing the attempts of a stealer.

1-12-10. The Physical Mark May be a Clue to Transfer the Online Service when the Copy is Transferred.

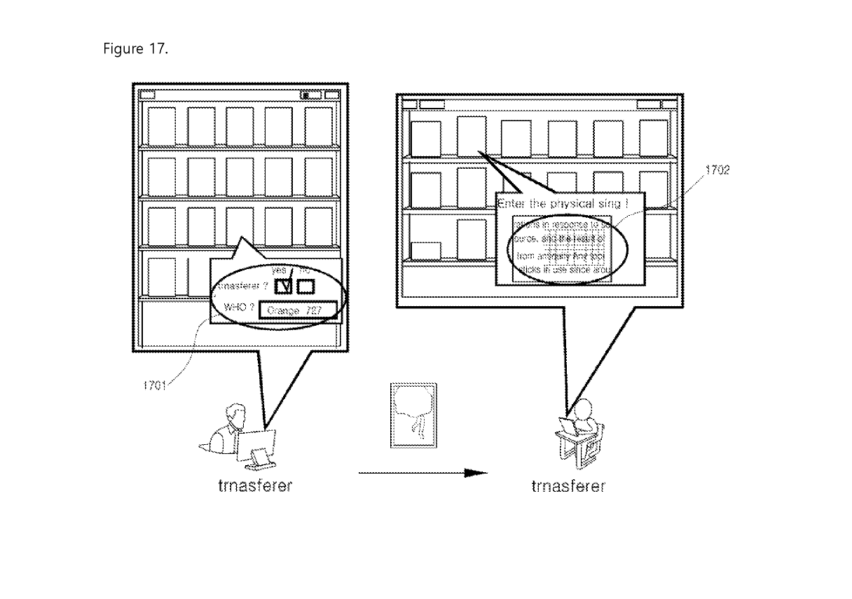

If the physical mark satisfies the condition described in (ch1-12-9), when a specific copy having a physical mark left therein is transferred to someone, the system can make an online service for the specific copy also transferred to the transferee. To this end, the transferrer and the transferee of the specific copy must play separate roles. FIG. 17 shows the role of these “transferrer” and “transferee”′. First, the transferrer (A) transmits a specific copy (B) to the transferee (C), and then connects the system server through his/her client device so as to notify that he/she has transferred the specific copy (B) to the transferee (C). First, the transferrer (A) shows a “transfer intention” with respect to the specific copy (B) and inputs to whom it is transferred (FIG. 17—1701). Thereafter, the transferee (C), who has received the specific copy (B) online, connects to the system server via his or her own client device and identifies the physical mark left in the specific copy (B) to the system server (FIG. 17—1702). Thereby, the system can confirm that the specific copy (B) is transferred from the transferrer (A) to the transferee (C), thereby changing the owner of the specific book (B) from the transferrer (A) to the transferee (C) and providing an online service for the specific copy (B) to the transferee (C).

1-12-11. Physical Marks can be Used for Copy Protection of a Copy.

If a specific copy, which is issued with a digital copy from the system, is reproduced and distributed to a person other than the owner of the copy, serious copyright issues may arise. Therefore, the system can prepare for copyright issues that may occur in the future by leaving a physical mark with the function of reproduction protection by a mechanical device in the copy (a copy having already issued the online service) which is issued with the digital copy by the system.

1-12-11-1. A Physical Mark Reflecting Light by a Mechanical Device

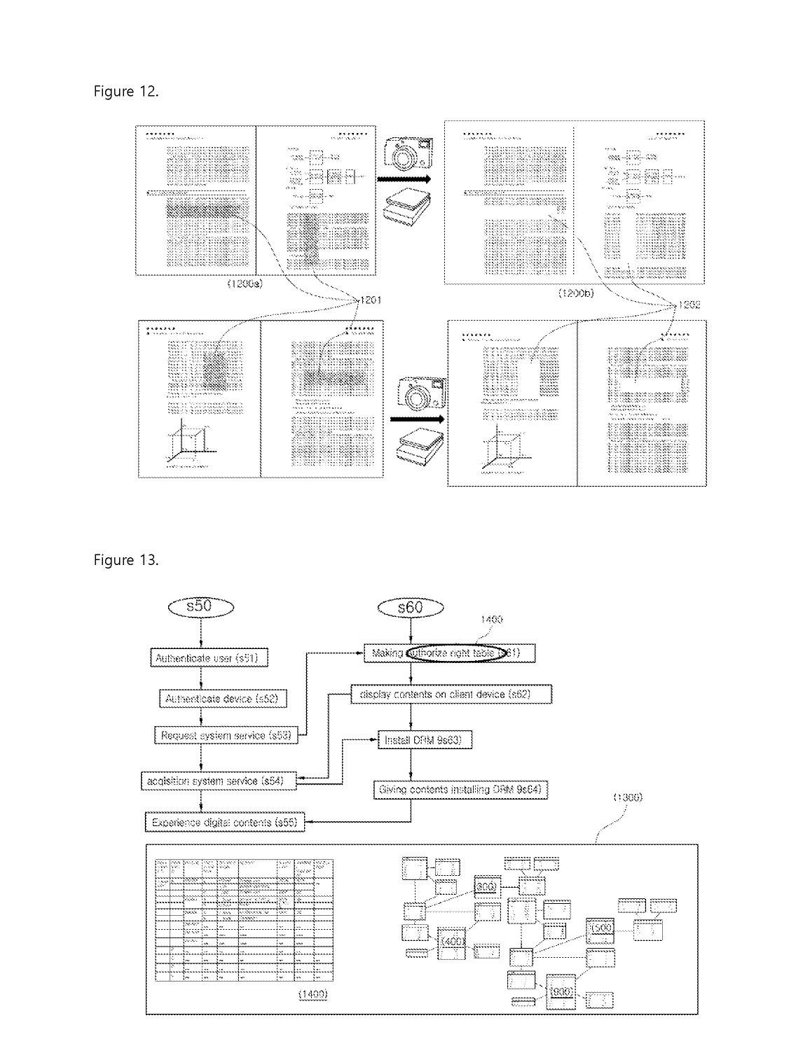

There might be an ink/sticker having a special component which is not perceptible to the human eye when provided on a copy, but reflects light emitted from a mechanical device (for example, a camera and a scanner) when the mechanical device performs reproduction (scanning and imaging). If the ink/sticker is taken/attached so as to overlap with the printing area of a copy (for example, a portion printed at the printing shop when printed, such as texts, images, etc.), the users can clearly recognize the print, but the portion having the physical mark, of the replica is distorted. FIG. 12 is a good example for this. The sticker (1201) attached so as to overlap with the printing area of a paper book (1200a) is transparent/semi-transparent so that the print under the sticker can be seen clearly, but reflects the strong light emitted by the optical mechanical device (a camera, a scanner, and a copy machine), thereby making an output (1200b) appear distorted (the printing area looks blurry or distorted).

1-12-11-2. A Physical Mark that Frustrates the Operation of a Reproduction Device

In order to realize the value of copyright protection in real life, if the government politically forces the operation of a reproduction device (for example, a scanner, a copying machine, etc.) after confirming the non-existence of physical marks, the physical mark left by the system at a specific position can be regarded as a kind of “official announcement means” announcing “reproduction is not permitted”. To achieve this, the system must physically make a mark, which is hard to artificially damage, at the “promised position” that users are familiar with. Then, each reproduction device shall determine “whether there is a physical mark” at a specific position of a copy whenever the reproduction of the copy is being made. Preferably, the reproduction device is provided with related elements (hardware and software) such that the reproduction device is connected to a specific server through a communication network and performs reproduction only after receiving a “permission” of the communication network. For example, the system may leave a physical mark (for example, a puncture, an indelible stamp, and a sticker that tears off the paper book when coming off), which is hard to damage, at a promised specific position (for example, the right bottom of the front cover) of a copy which has issued an online service. The reproduction device may request a person to let the device identify the specific position (for example, the right bottom of the front cover) of a paper book to be reproduced, and may perform reproduction after confirming that there is no identification marks at the specific position.

### 2. System Process

FIG. 1 illustrates components required for a system and a relationship between the components through a representative embodiment. (It should be noted that the series of steps (s10 to s50) shown in the figure are artificially listed so as to help intuitive understanding of the overall process of the present invention and it is not necessary to perform the steps in order, for achieving the purpose of the present invention.)

The components of the system are connected to the system server (60) by a communication network through the Internet and a network, and the system server (60) is operatively connected to one or more DBs. First, content providers (10) access the system server with the content provider authority, and upload one or a plurality of content owned by the content providers (10) to the system server (60) in addition to the description related thereto (s10). Content managers (20) access the system server with the content manager authority, and control the users' access to each content (s20). Rights sponsors (30) access the system server with the right sponsor authority and sponsor all or part of the requirements necessary for the owner of a copy of a specific paper book to access/use the content associated with the specific paper book (s30). On the other hand, system authenticators (40) access the system server with the system authenticator authority so as to make the system server identify that a specific system user owns a specific copy, while receiving the copies from the owners (50) offline or selling the copies to the system users online/offline (s40). Thus, the system server (60) can grasp who owns which paper book, and collects the information collected through (s10), (s20), (s30), and (s40) described above through relational operation, and creates “a content usage right table” that specifies content and a usage rule, the content to be provided to a specific system user by the usage rule. Thereafter, the copy owners (50) access the system through their client devices, passes through the user/device authentication, receive an online service individually granted to them by the system server in reference with the table, and then experiences digital content (s50).

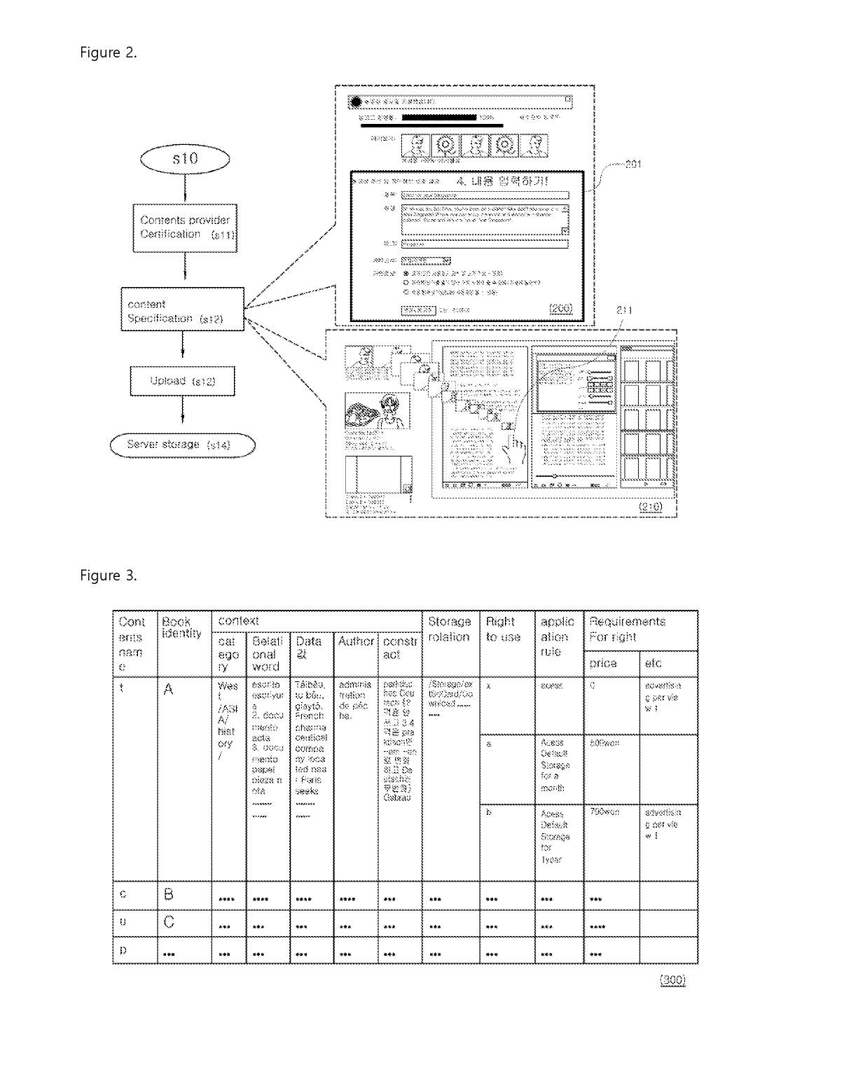

FIG. 2 specifically shows (s10) in FIG. 1, illustrating a method of creating content on a system server by a content provider (10) in one embodiment. The content provider has the authority to upload content and to specify the context of the content by accessing the system server with the content provider authority through some authentication (FIG. 2—s11). The content providers want their digital content to be exposed to many people, leading to purchases, and post or upload their own digital content. (FIG. 2, 200, 210) relates to an interface experienced by a content provider in one embodiment. The content provider may manually enter context through a monitor as shown in (FIG. 2—200), may directly select a specific book to be associated through an intuitive interface as in (FIG. 2—210), drag and drop his/her own specific content to a page, a phrase, a word, an image, etc. to be associated, or may simply enter the information that the system needs. Such an intuitive application program will extract information necessary for the system from these actions of the provider and transmit the same to the server (FIG. 2—s13), and the transmitted information will be stored in such a table as in (FIG. 3—300) in a DB.

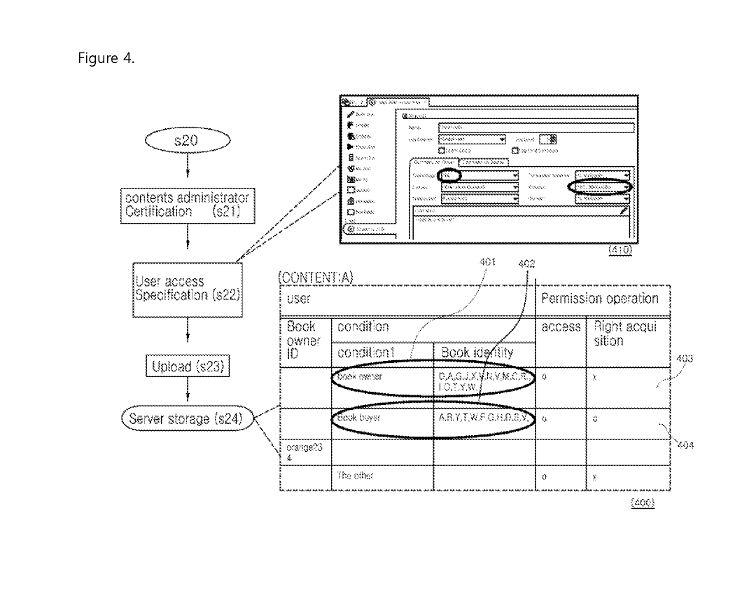

FIG. 4 specifically shows (s20) in FIG. 1, illustrating a method in which a content manager (20) controls user access to content in an embodiment. The content manager complies with the system operation policy to limit the unauthorized access/use of arbitrary system users to myriad digital content existing in a database, and to provide opportunities for only authorized users to access the content and gain a right to use the content. Accordingly, the content manager is authorized to control user access to the content from the system by accessing the system with the content administrator authority via some authentication (FIG. 4—s21). (FIG. 4—410) is an interface provided to the content manager from the system. The content manager specifies “user conditions” and “allowable operations” for specific content by referring to the system operation policy (what operation is permitted to whom). (FIG. 4—400) represents a relation instance created by a specific content provider with respect to specific content A, according to an embodiment. The content manager may specify a specific user, specify the conditions of the user, and specify an allowance operation accordingly. For example, in the case of (403), the content manager allows the users corresponding to (401) to access the content A, but does not allow the opportunity to “gain a right to use”. That is, the users corresponding to the above (401) can search for and find the content A on their client device screens, but a usage right gaining button is inactivated. On the other hand, in the case of (404), the users corresponding to (401) can search for and find the content A on their client device screens, and the usage right gaining button is activated. The reason why the system differentiates the allowable operations of the system users with respect to specific content is to induce, by the system, users' behavior in a specific policy way. For example, if the content manager has a policy as in (FIG. 4—400) for specific content, a user who wants to experience the content A among the users corresponding to (401) must hold the qualification of (402). Therefore, the user may purchase a new paper book.

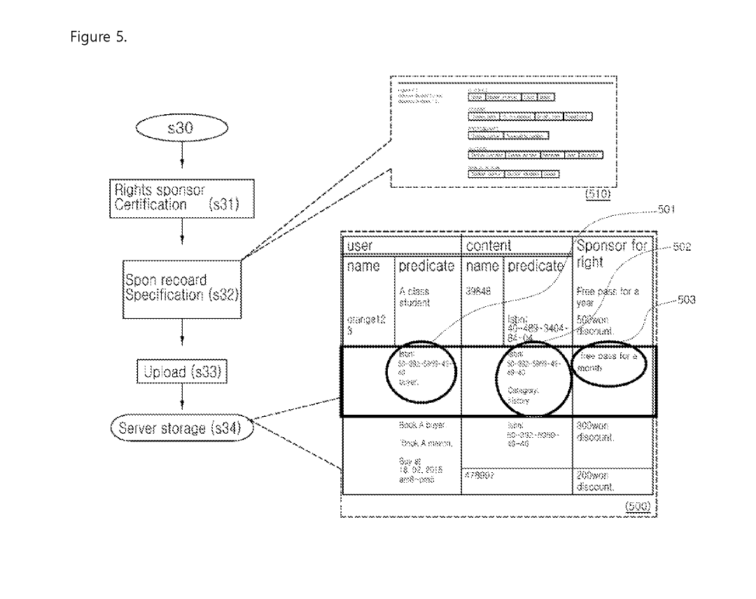

FIG. 5 specifically shows (s30) in FIG. 5, illustrating a method sponsoring, by a right sponsor (30), a right to system users in one embodiment. The right sponsor has the authority to access the system server through a few authentication (FIG. 5—s31) processes and to sponsor a right to a specific system user. Thereafter, the system will enter the necessary information (FIG. 5—s32) through an interface of the system application provided for the rights sponsor (FIG. 5—510). (FIG. 5—500) relates to a relation instance generated by a specific right sponsor in one embodiment (FIG. 5—504), and (FIG. 5—504) shows that when system users (502) corresponding to (501) desire to purchase a right to use corresponding content, the system users request the system server to sponsor a right corresponding to (503).

FIG. 6 specifically shows (S40) in FIG. 1, illustrating the role of a system authenticator (40) in one embodiment.

Since the system authenticator (40) plays a role of informing the system of who owns a book, the system authenticator may be a subject who sells books at online and offline bookstores or a subject who receives a copy from the copy owner offline and does business for the authentication in reality. Assuming a situation where the system authenticator sells a book to someone (FIG. 6—s41), the system authenticator will connect to the system server with the system authenticator authority through a few authentication processes (FIG. 6—s43). The system application inputs identifier information (for example, ID) of a specific system user and identifier information (for example, an ISBN) necessary for identification of the book identity of a specific copy through a separate interface provided for the authenticator (FIG. 6—s45), and notifies the system server that the specific system user owns the specific copy. Thereafter, the system authenticator then leaves a physical mark in the specific copy in accordance with an “authenticator behavior rule” (FIG. 6—710) (FIG. 6—s46), and then the same is delivered to a buyer of the specific copy (FIG. 6—s47). On the other hand, if the system authenticator is the subject who receives the copy from the copy owner offline and authenticates the system, the system authenticator acquires the specific copy from the owner of the specific copy (FIG. 6—s42), passes through an authentication process (FIG. 6—s43), and then has to check whether there is a “physical mark” in the copy to determine whether the copy is a book that has been previously issued with a system service by someone (FIG. 6—s44). At this time, if it is confirmed that the “physical mark” is present, the system service is immediately rejected (FIG. 6—43.3), and if it is confirmed that there is no “physical mark”, the authenticator sequentially executes (FIG. 6—s45, 46, 47) in the same manner as the process described above.

The roles of the system authenticator are classified and described in detail below.

Work for Exploration of Presence or Absence of Physical Marks

In the above-described series of steps, a step of searching for a physical mark in the copy will be specified (FIG. 6—s44). In the present invention, this process will be referred to as a “work for exploration of presence or absence of physical marks”. It does not matter if the system authenticator knows the position of a “physical mark” in advance, but if not, the authenticator will “request” the server to guide the “position” of a “physical mark”, and the server may guide the position of the physical mark in response to the request. (FIG. 6—600) relates to an embodiment of (FIG. 6—s44), wherein a step in which the server guides the position of the physical mark and the system authenticator accordingly searches for the physical representation is shown. First, the authenticator requests (FIG. 6—441) to guide the position of the physical mark. In response, the server computes the values for the “position” attribute in the internal protocol. (FIG. 7—700) is an internal protocol in which an “authenticator behavior rule” (tuple) consists of three physical marks. The server finds a domain by searching the position attribute's value (FIG. 7—701, 702, 703, 704, 705 . . . ) of the 1st physical mark in each tuple, treats the same as a 1st key, and presents the same to the authenticator (FIG. 6—443). (Note that there may be multiple 1st keys at this time.) After that, the authenticator confirms whether there is a physical mark at the position indicated by the 1st key by the server (FIG. 6—444), and notifies the server if there is no physical mark. Then, the system searches for the position attribute's value of a 2st physical mark in each tuple in the same way as the 1st key computation, and outputs a 2st key to the authenticator (FIG. 6—445). Thereafter, a 3st key is computed in the same manner and presented to the authenticator (FIG. 6—447). If it is confirmed that there is no physical mark at each step, the server causes the authenticator to enter the next step (s45) and a physical mark is found in the process, the server immediately refuses to proceed to the next step (s43.3).

Authenticating that a Specific Copy is Owned by a Specific System User

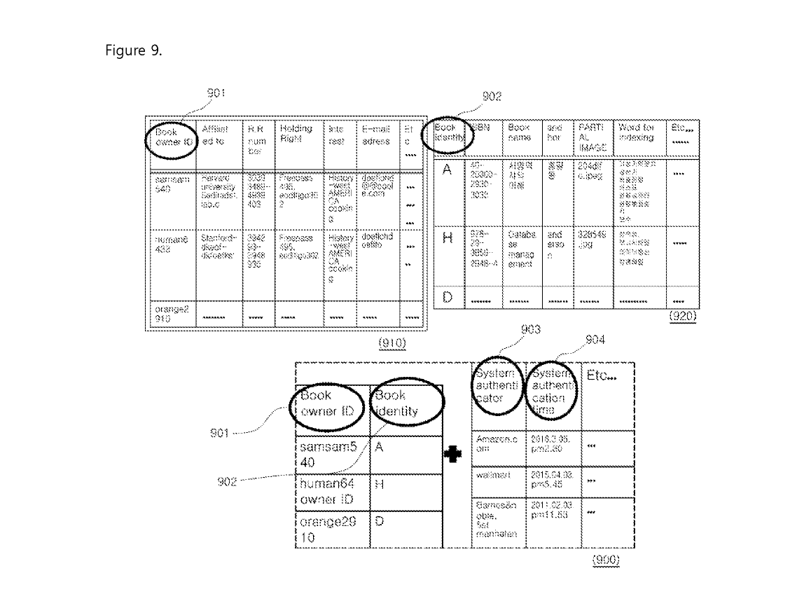

In the above-described series of steps, a step of (FIG. 6—s45) of authenticating, the server, that a specific system user owns a specific copy will be specified. If it is determined that the book has no physical mark, the authenticator accesses the server and inputs identifier information (for example, ID) of a buyer or owner of a specific copy and identifier information (for example, an ISBN) indicating book identity of a specific copy. (FIG. 9—900) represents a relation instance, according to an embodiment, in which an input of an authenticator is stored in a DB. At this time, the authenticator can be used as a source to associate with other information by adding an extra field (FIG. 9—903, 904 . . . ). (FIG. 9—900) entered by the authenticator can be operated in relation to the extra information that the server previously had. (FIG. 9—910) is information input by the system user at the time of subscription to the system, and (FIG. 9—920) is context information held by the system for a specific book identity. In addition, the DB can refer to other relations and can create the information needed by the system.

Leaving a Physical Mark

In the above-described series of steps, the steps (FIG. 6—S46) in which the system authenticator leaves a physical mark on a copy will be specified.

If it is easy for an authenticator to be familiar with the “authenticator behavior rule”, the authenticator simply needs to leave a physical mark on the paper book in accordance with the “authenticator behavior rule” that he/she is familiar with.

However, if the internal protocol is complicated and difficult to learn in advance, the authenticator requests the server's guidance, and the server must select/create a specific “tuple” with reference to the “internal protocol” and present the same to the authenticator.

An authenticator merely needs to leave a physical mark in the copy in accordance with the presented “authorizer behavior rule”.

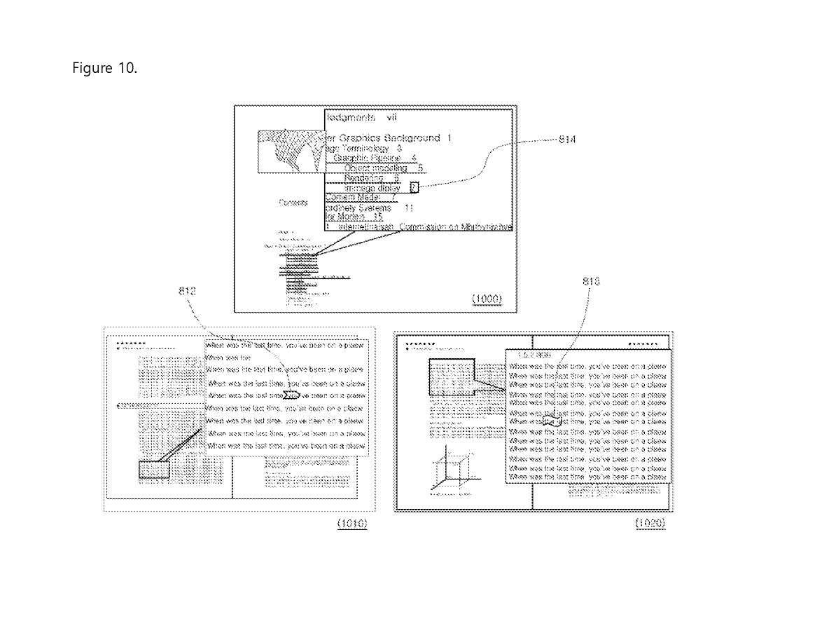

Preferably, the subject performing this role may be a mechanical device. (FIG. 10—1000, 1010, 1020) may show three physical marks made in the copy by the authenticator in accordance with a specific “authorizer behavior rule” (810) presented by the system server referring to the internal protocol (FIG. 8—800).

In (FIG. 10—811), (FIG. 8—811) is specified and (FIG. 10—812) and (FIG. 10—813) show (FIG. 8—812) and (FIG. 8—813) implemented in a copy, respectively.

For detailed information on the “internal protocol” that actually controls the authenticator's behavior, see (ch 1-12).

Finding Stealers with Physical Marks

In reality, a person who temporarily holds a book by stealing or renting the same may receive a system service from the system by deceiving as if he/she owns the book that he/she does not own. At this time, if the system has presented a unique “authenticator behavior rule” for a specific system user/specific copy, the system authenticator identifies a “physical mark” left in the copy and makes the system identify the attribute value thereof, thereby confirming who has been issued with the service and finding a “stealer”. Preferably, the system authenticator will search the position of the physical mark guided by the system server and make the system identify the attribute values of the physical mark found. The system server responds in an end-to-end feedback manner to the inputs of these authenticators, finally identifying unique tuples. (In the end-to-end feedback method, a unique entity (tuple) is identified through a set of feedback in which a server receiving an attribute value inputted by a client selects a tuple having the same as an attribute value, extracts a candidate key from the selected tuples, and presents the client key to the client, and the client inputs the attribute value for the presented key.

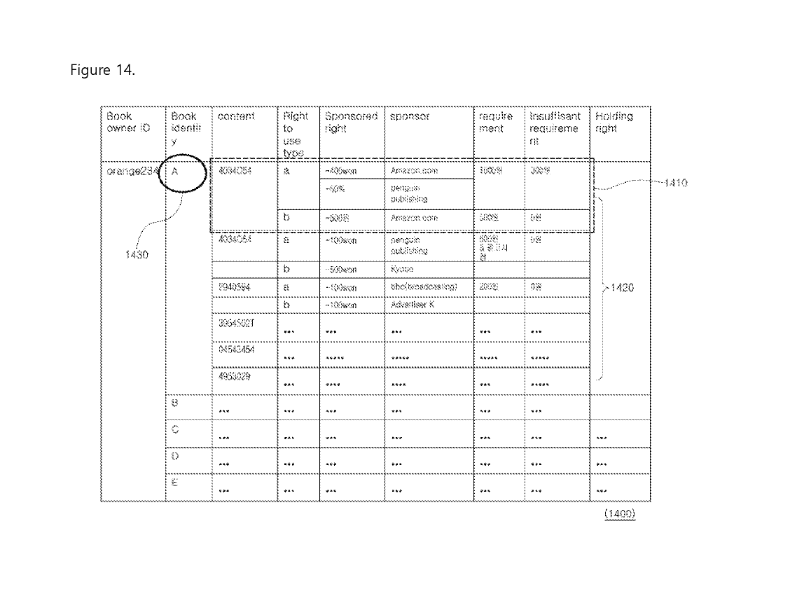

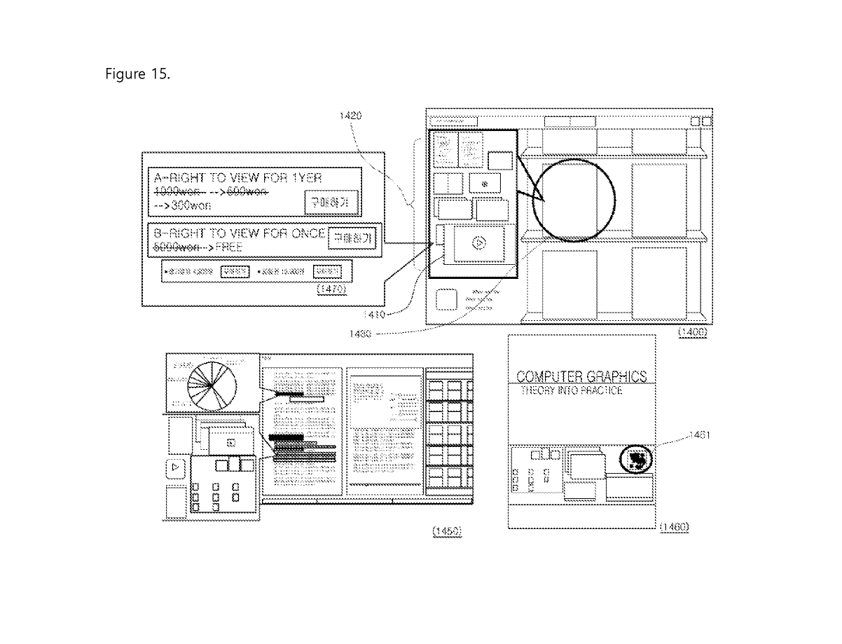

FIG. 13 specifically shows (s50) and (s60) in FIG. 1. In one embodiment, a step in which a copy owner (50), who gets copy in which a physical mark is left, back from an authenticator and is provided with a service from the system through his/her own client device is indicated. First, user authentication (s51) will be described. To authenticate that the user has purchased or allowed to use content, various information (for example, a resident registration number and a system ID) can be utilized to uniquely identify the user. When the security of the client device of the specific system user is released, the user requests a system service from the server (s53). In response, the server creates a “content usage right grant table” (hereinafter, referred to as a “right table”) of the requestor (s61). (FIG. 13—1300) shows the process of creating the “right table”. The system stores the information transmitted by the components of the system (a content provider, a system authenticator, a right sponsor, a content manager, etc.) to the server as relations (FIG. 13—300, 400, 500, 900), relationally computes the same (FIG. 13—1400), and creates a “right table” (FIG. 13—1400). A detailed description of how each relation is finally made into a “right table” through what operation can be easily understood by those skilled in the art, who understand each relation, so a detailed description thereof will be omitted. However, let's take a more concrete look at what the “right table” created through complex computation means. (FIGS. 14—1400), in one embodiment, is a “rights table” assigned to a specific system user, which indicates which specific system user has a right to use what content with what usage rule. According to this, a specific system user (ID: orange 234) has a total of five copies (A, B, C, D, and E). A total of six contents can be provided to the user (ID: orange 234) by the system in association with A. At this time, the wording “can provide” means that there are six content in which the user is given the opportunity to acquire a usage right. That is, although the user can see a lot of content in association with A on the screen of the client device, the user can access and buy only six content. In other words, the above six content will be displayed with the “purchase” button activated and the other content will be displayed with the “purchase” button inactivated. Take specific content (1410) as an example. The content has two types of usage rights. In order to acquire a right to use A, the “requirement” provided by the content provider is “1000 won”. The “requirement” required to obtain the right to use B is “500 won”. However, the user (ID: orange 234) has two sponsors for the usage right A, wherein amazon.com is the first sponsor, sponsoring 400 won, and penguin publishing is the second sponsor, sponsoring 50% of the shortage of the requirements. Therefore, in order for the user (ID: orange 234) to acquire the usage right A, 300 won, which is the rest of the sponsoring, must be further paid. Such a series of matters can be seen on the user's device screen in reality (FIG. 15—1400). If the user points out a book A (1430) among the various books (A, B, C, D, . . . ) displayed on the screen, various content provided by the system in association with A is rendered (1420). If one of the content (FIGS. 14 and 15—1410) in which the “purchase” button is activated is pointed out (FIGS. 14 and 15—1410), the details of the rights assigned to the user are rendered, as shown in (FIG. 15—1470). In addition, if the right table additionally has information such as a specific page, phrase, word, etc. of the paper book associated with each content, the user can select whether the content is associated with the specific word, phrase, sentence, etc. of the specific paper book.

In one embodiment, in order to promote what online service is provided by a system for a specific paper book in a typical offline bookstore, the system prints a code (1461) on the binding of a paper book as shown in (FIG. 15—1460) and allows users to preview the services provided by the system for the paper book by using the code as a pointer.

What is claimed is:

1. In a method providing, to a specific system user owning a specific copy of a specific paper book, digital content complementary to the specific paper book, the method used in a system in which a client device of the specific system user is connected to a system server through a communication network and comprising the steps of:
(a) confirming, after a system authenticator has received the specific copy of the specific paper book from the specific system user, that there is no “physical mark” made by the system authenticator in the specific copy, or selling, by the system authenticator the specific copy of the specific paper book to the specific system user;
(b) informing, by the system authenticator, the system sever of that the specific system user owns the specific copy, and requesting provision of an online service relating to the specific paper book for the specific system user;
(c) making, by the system authenticator, a “physical mark” on the specific copy by complying with an “authenticator behavior rule” according to an internal protocol of the system, and transmitting the specific copy to the specific system user;
(d) providing, by the system server, an online service to the specific system user in response to step (b); and
(e) making the specific system user experience digital content complementary to the specific paper book by using the online service provided in step (d) through his/her own client device.

2. The method of claim 1 further comprising, prior to step (b), the steps of:
(a) associating, by a content provider, specific content and the context thereof with the specific paper book and uploading the same to the system server; and
(b) granting, by a content manager, a right to gain an online service-access right/usage light for the specific content to the owners of the copies of the specific paper book.

3. The method of claim 2 further comprising the step of:
sponsoring a part or all of the conditions required for the right sponsor to gain the access right/usage right for the specific content to the specific system user.

4. The method of claim 1 wherein step (a) includes the feature of referring to the guidance of the system server referring to the internal protocol so as to confirm, by the system authenticator, that there is no physical mark in the specific copy.

5. The method of claim 1 wherein step (c) includes the feature of the “authenticator behavior rule” including a plurality (n) of physical marks so as to prepare for damage to the physical marks.

6. The method of claim 1 wherein step (c) includes the feature of the “authenticator behavior rule” immediately presented by the system server receiving the request of the system authenticator.

7. The method of claim 6 wherein the “authenticator behavior rule” is unique to the specific system user or the specific copy.

8. The method of claim 7 wherein to represent uniqueness, the combination of attribute values of selected physical marks when there is a plurality of physical marks, wherein some (n) of the physical marks are randomly selected.

9. The method of claim 7 wherein as a way of representing uniqueness, a plurality of physical marks, each of which has a unique attribute value, is made and when grouping the same into several groups, the position value of a specific physical mark (m) of a preceding group and the position value of a specific physical mark (g) of a subsequent group are matched such that (g) can be referred even when (m) is damaged.

10. The method of claim 7 wherein as a way of representing uniqueness, when a sticker or stamp, which is attached/printed somewhere in a printing area (an area in which texts, images, etc. are printed) of the specific copy, in a specific pattern is imaged by an optical mechanical device (for example, a scanner), the sticker or stamp is attached/printed somewhere in the printing area such that an obtained image is uniquely identified by the system.

11. The method of claim 1 wherein step (c) includes the feature of the “physical mark” made at one position or one of a plurality of positions selected by the system in advance.

12. The method of claim 1 wherein step (c) includes the feature of the “physical mark” which is not damaged easily and is made by a means leaving a physical trace against damage thereto, thereby enabling the system authenticator to easily recognize whether the physical mark is damaged or not.

13. The method of claim 1 wherein step (c) includes the feature of the “physical mark” made by a means perceptible to the human eye and only mechanically identified, thereby being protected against artificial damage thereto.

14. The method of claim 1 wherein step (c) includes the feature of the “physical mark” which is perceptible to the human eye but is made as if the physical mark were a part of the specific copy (in other word, as if the physical mark has been printed at the time of publication thereof), thereby being protected against artificial damage by somebody.

15. The method of claim 1 wherein step (c) includes the feature of the “physical mark” which is not identified to the system based on a keyboard and is only identified to the system through an optical mechanical device (for example, a camera and a scanner) provided in a client device of the specific system user, is hard to reuse when separated from the specific copy, and is transmitted to the system server at the time of being imaged by the optical mechanical device so as to be used as a clue for grasping whether “the specific system user still owns the specific copy”.

16. The method of claim 1 wherein step (c) includes the feature of the “physical mark” which is attached to/printed in a random area (k) of the printing area (for example, texts, images, etc.) of the specific copy in a transparent/semi-transparent manner and has penetrability such that (k) is perceptible to the human eye but reflects light emitted from an optical device (for example, a camera and a scanner) for reproduction when the optical device is executed, thereby making (k) appear distorted and hindering the attempts to reproduce the specific copy.

17. The method of claim 15 further comprising, after step (e) so as to allow, when the specific system user (M) transfers the specific copy (P) to another specific system user (N), the online service provided to the specific system user (M) to be also transferred to the another specific system user (N), the steps of:
(a) transferring the specific copy (P) to the another specific system user (N) by the specific system user (M) offline;
(b) informing that the specific system user (M) accesses the system server via his or her own client device and transfers the specific copy (P) to the another specific system user (N);
(c) authenticating, by the another specific system user (N), that the another specific system user has been transferred with the specific copy (P) from the specific system user (M) and owns the same by accessing the system server via his or her own client device and making the system identify a “physical mark” made in the specific copy (P); and
(d) interrupting, by the system server, an online service, which has been provided for the specific system user (M) for the specific copy (P), in response to steps (b) and (c) and providing the same to the another specific system user (N).

18. The method of claim 1 wherein some or all of the roles of the system authenticator according to steps (a) to (b) are performed by a machine specially designed by the system so as to perform the role of the system authenticator.

19. A user system including a means for performing the method according to any one of claims 1 to 18.
